(19) United States
(12) Patent Application Publication
(10) Pub. No.: US 2019/0080319 A1
(43) Pub. Date: Mar. 14, 2019

(54) SYSTEMS AND METHODS FOR TOKEN VAULT SYNCHRONIZATION

(71) Applicant: JPMorgan Chase Bank, N.A., New York, NY (US)

(72) Inventor: David Christopher Carey, Middletown, DE (US)

(21) Appl. No.: 15/700,866

(22) Filed: Sep. 11, 2017

(51) Int. Cl. G06Q 20/36; G06Q 20/40; G06Q 20/34

(52) U.S. Cl. CPC G06Q 20/3674; G06Q 2220/00; G06Q 20/341; G06Q 20/4014

(57) ABSTRACT

Systems and methods for token vault synchronization are disclosed. In one embodiment, in a third party provider information processing apparatus comprising at least one computer processor, a method for token vault synchronization using a third party provider may include (1) receiving, from a computer program executed by an electronic device associated with a customer, a request to provision an identifier for an account associated with the customer to the computer program; (2) generating the identifier; (3) creating an association of the identifier and the account; (4) storing the association of the identifier and the account in a third party provider vault; (5) electronically communicating the association of the identifier and the account to an issuer of the account; (6) receiving a cryptogram from the issuer; (7) electronically communicating the cryptogram and the association of the identifier and the account to the computer program.

### BACKGROUND OF THE INVENTION

### Field of the Invention

The present disclosure generally relates to systems and methods for token vault synchronization.

### Description of the Related Art

Tokens are used as a security measure when conducting a transaction using, for example, a mobile wallet hosted by a mobile electronic device, such as a smartphone. Rather than conduct a transaction using a customer's primary account number (PAN), a token (also known as a digitized PAN, or DPAN), which is a surrogate for the PAN, is used.

A token vault, which is a secure centralized server that stores the PANs and tokens, as well as their mappings. The token vault is maintained by a token service provider, or TSP. Credit card associations, such as Visa and MasterCard, often provide TSP services.

### SUMMARY OF THE INVENTION

Systems and methods for token vault synchronization are disclosed. In one embodiment, in a third party provider information processing apparatus comprising at least one computer processor, a method for token vault synchronization using a third party provider may include (1) receiving, from a computer program executed by an electronic device associated with a customer, a request to provision an identifier for an account associated with the customer to the computer program; (2) generating the identifier; (3) creating an association of the identifier and the account; (4) storing the association of the identifier and the account in a third party provider vault; (5) electronically communicating the association of the identifier and the account to an issuer of the account; (6) receiving a cryptogram from the issuer; (7) electronically communicating the cryptogram and the association of the identifier and the account to the computer program.

In one embodiment, the method may further include electronically communicating the cryptogram and the association of the identifier and the account to an association associated with the account.

In one embodiment the computer program may be a mobile electronic wallet, a payment application, etc.

In one embodiment, the account may be a credit card account, and the association may be a credit card association.

In one embodiment, the method may further include authenticating the customer; and electronically activating the identifier.

In one embodiment, the identifier may be a token.

In one embodiment, the method may further include receiving an update for the identifier; and electronically communicating the update to at least one of the computer program and the issuer.

In one embodiment, the method may further include receiving an update for the identifier; and electronically communicating the update to at least one of the computer program, the issuer, and the association.

According to another embodiment, a system for token provisioning using a third party provider may include an electronic device comprising an electronic device computer processor executing a computer program; a third party provider information processing apparatus comprising a third party provider computer processor; an association information processing apparatus comprising an association computer processor; and an issuer information processing apparatus comprising an issuer computer processor. The third party provider information processing apparatus may receive from the computer program a request to provision an identifier for an account associated with a customer to the computer program; generate the identifier, create an association of the identifier and the account; store the association of the identifier and the account in a third party provider vault; communicate the association of the identifier and the account to the issuer information processing apparatus; receive a cryptogram from the issuer information processing apparatus; and electronically communicate the cryptogram and the association of the identifier and the account to the computer program.

In one embodiment, the third party provider information processing apparatus may electronically communicate the cryptogram and the association of the identifier and the account to the association information processing apparatus.

In one embodiment, the computer program may be a mobile electronic wallet, a payment application, etc.

In one embodiment, the account may be a credit card account, and the association may be a credit card association.

In one embodiment, the third party provider information processing apparatus may authenticate the customer, and electronically activate the identifier.

In one embodiment, the identifier may be a token.

In one embodiment, the third party provider information processing apparatus may receive an update for the identifier and electronically communicate the update to at least one of the computer program and the issuer information processing apparatus.

In one embodiment, the third party provider information processing apparatus may receive an update for the identifier and electronically communicate the update to at least one of the computer program, the issuer information processing apparatus, and the association information processing apparatus.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a block diagram of a system for token vault synchronization according to one embodiment.

FIG. 2 depicts a block diagram of a system for token vault synchronization according to another embodiment.

FIG. 3 depicts a method for provisioning a card using a token service provider according to one embodiment.

### DETAILED DESCRIPTION OF PREFERRED EMBODIMENTS

Embodiments disclosed herein are directed to a system and method for token vault synchronization. In one embodiment, a third party token service provider be used instead of credit card associations token service provider capabilities.

Although this disclosure is made in the context of a token service provider and tokens, this is not limiting. Third party providers, and other identifiers, may be used as is necessary and/or desired.

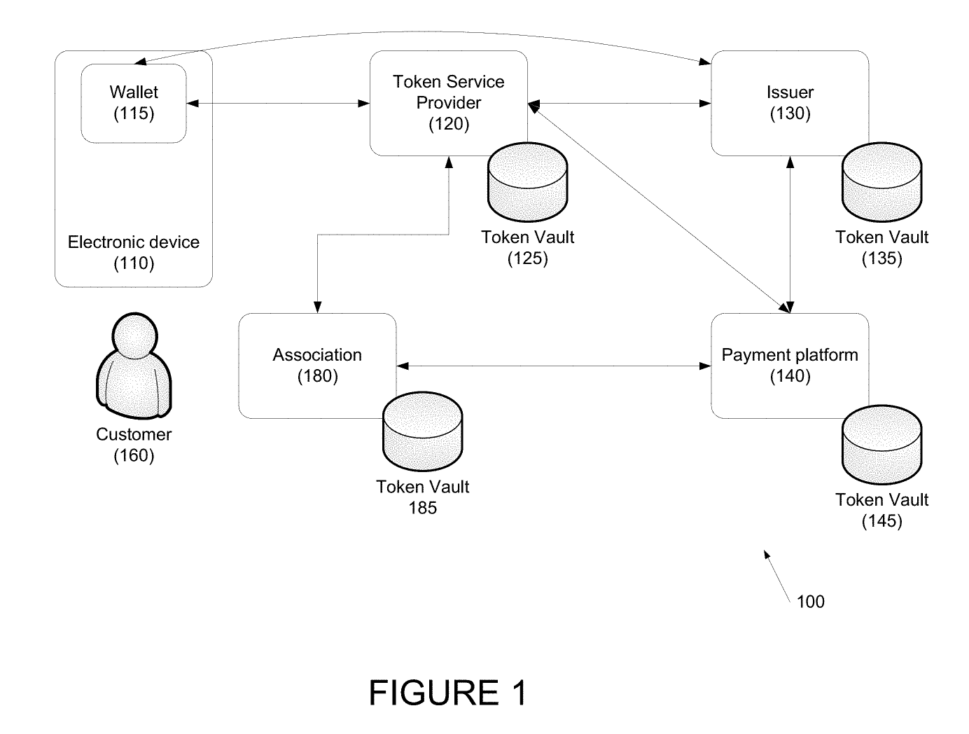

Referring to FIG. 1, a block diagram of a system for token vault synchronization according to one embodiment is disclosed. System 100 may include electronic device 110 that may include electronic wallet 115. In one embodiment, electronic device may host or execute an application providing a payment service, such as ApplePay, SamsungPay, AndroidPay, etc.

Customer 160 may interact with electronic device 110.

System 100 may further include a third party, such as token service provider 120 that may manage identifies that may be associated with a transaction account issued by issuer 130. For example, the identifiers may be tokens, or DPANs, for credit cards issued by issuer 130. In one embodiment, token service provider 120 may maintain token vault 125.

Association 180, such as Visa or MasterCard, may maintain token vault 185. In one embodiment, token service provider 120 may push updates to association 180 to keep token vault 125 and token vault 185 synchronized.

Issuer 130 may maintain token vault 135, and payment platform 140 may maintain token vault 145. In one embodiment, issuer 130 and/or payment platform 140 may communicate with token service provider 120 to keep token vault 125, token vault 135, and token vault 145 synchronized.

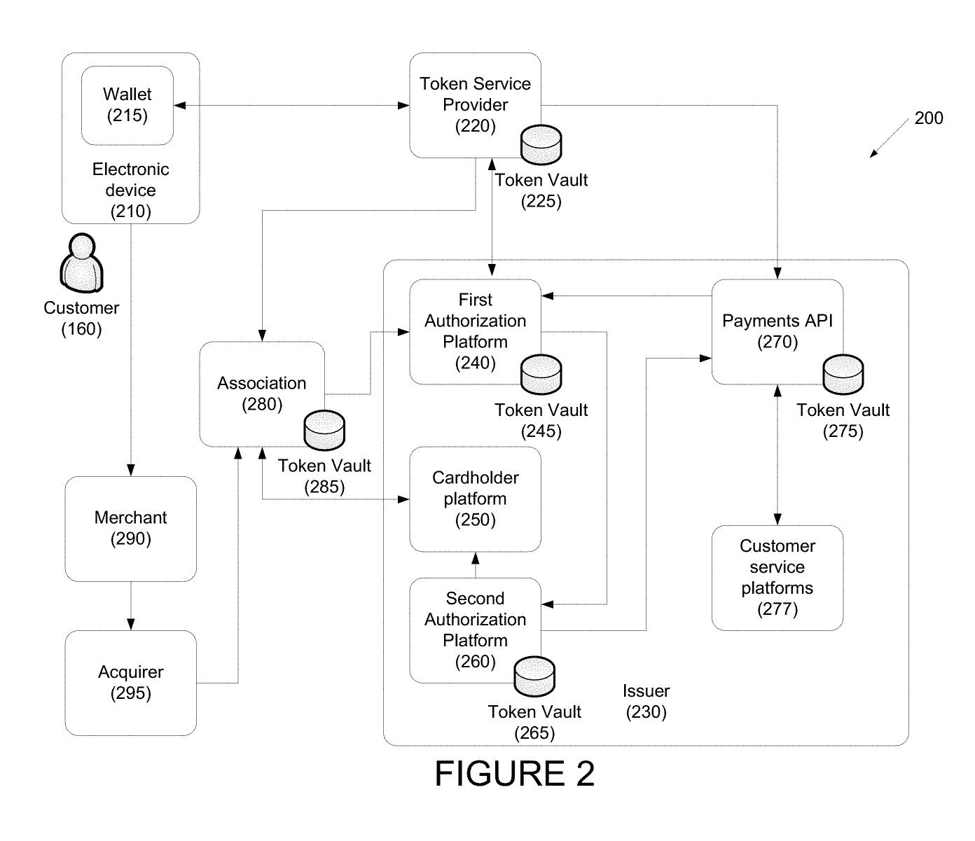

Referring to FIG. 2, a block diagram of a system for token vault synchronization according to one embodiment is disclosed. System 200 may include electronic device 210 that may include electronic wallet 215. In one embodiment, electronic device may host or execute an application providing a payment service, such as ApplePay, SamsungPay, AndroidPay, etc.

Token service provider 220 may manage tokens for issuer 230, which may include first authorization platform 240, second authorization platform 260, cardholder platform 250, payment API 270, and customer service platforms 277. In one embodiment, token service provider 220 may maintain token vault 225.

In one embodiment, first authorization platform 240 may authorize a portion of a transaction, and second authorization platform 260 may authorize other portions of transactions. For example, second authorization platform may authorize off-line transactions.

In one embodiment, customer service platform(s) 277 may receive changes (e.g., cancellation, updates, etc.) and may provide them to payments API 270 for writing to token vault 275. In response, token vaults 225, 245, 265, and 285 may be synchronized.

In one embodiment, cardholder platform 250 may be the system of record for issuer 230, and may maintain account information, personal information, etc.

First authorization platform 240, second authorization platform 260, and payments API 270 may maintain token vaults 245, 265, and 275, respectively.

Association(s) 280, such as Visa or MasterCard, may maintain token vault 285. In one embodiment, token service provider 220 may push updates to association 280 to keep token vault 225 and token vault 285 synchronized.

In one embodiment, first authorization platform 240, second authorization platform 260, and/or payments API 270 may communicate with token service provider 220 to keep token vault 225 and token vaults 245, 265, and 275, synchronized.

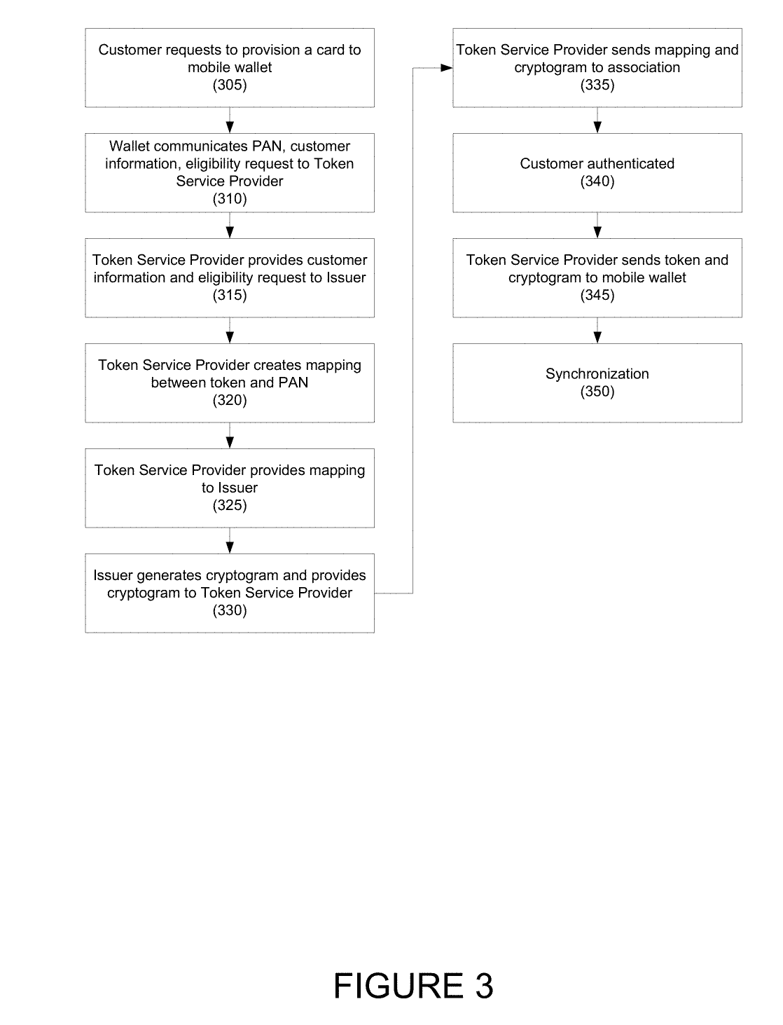

Referring to FIG. 3, a method for provisioning a card using a third party, such as a token service provider, according to one embodiment is provided. In step 305, using a computer application (e.g., a mobile wallet, a payment application, etc.) executed by an electronic device, such a mobile electronic device, a customer may request the provisioning of an identifier, such as token for a transaction account, to the customer's electronic wallet. In one embodiment, the customer may capture an image of, for example, a credit card and the characters on the credit card may be extracted from the image. In another embodiment, the credit card may already be stored in the computer application.

In another embodiment, the message may be requested by the issuer, by a third party (e.g., a wireless carrier, an electronic device manufacturer, etc.).

In step 310, the electronic wallet may collect data that may be necessary to provision the token, and may send a message including this data to the token service provider. Examples of data include a Primary Account Number, or PAN (e.g., credit card/account information), customer information, etc. In one embodiment, the message may include a request to check eligibility of the request and to provision a token.

In step 315, the Token Service Provider may communicate the customer identifier and the PAN to the issuer along with an eligibility request. In one embodiment, the issuer may then determine eligibility for the PAN.

In step 320, the Token Service Provider may generate or retrieve a token or DPAN, and may map the PAN to the token. The Token Service Provider may store the mapping in its token vault.

In step 325, the token service provider may provide the mapping, including the PAN and the token, to the issuer. The issuer may store the mapping in its token vault.

In step 330, the issuer may receive the mapping and may generate a cryptogram. The issuer may then provide the cryptogram to the Token Service Provider.

In step 335, the Token Service Provider may provide the mapping and the cryptogram to the association. The association may store the mapping in its token vault.

In step 340, the issuer may authenticate the customer using, for example, out-of-band authentication.

Once the customer is authenticated, in step 345, the token and the cryptogram, may be provided to the mobile wallet. The mobile wallet or the token may then be activated.

In step 350, the token vaults for the association, the token service provider, and/or the issuer may be synchronized. In one embodiment, periodically or as necessary. For example, the token service provider may provide a file periodically, on demand, or as necessary and/or desired to the issuer, the association, and any other entity as necessary and/or desired. This may be used to detect out of synch data, data anomalies, etc.

Although several embodiments have been disclosed, it should be recognized that these embodiments are not exclusive to each other.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for provisioning an identifier for an account using a third party provider, comprising:
in a third party provider information processing apparatus comprising at least one computer processor:
receiving, from a computer program executed by an electronic device associated with a customer, a request to provision an identifier for an account associated with the customer to the computer program;
generating the identifier;
creating an association of the identifier and the account;
storing the association of the identifier and the account in a third party provider vault;
electronically communicating the association of the identifier and the account to an issuer of the account;
receiving a cryptogram from the issuer; and
electronically communicating the cryptogram and the association of the identifier and the account to the computer program.

2. The method of claim 1, further comprising electronically communicating the cryptogram and the association of the identifier and the account to an association associated with the account.

3. The method of claim 1, wherein the computer program is a mobile electronic wallet.

4. The method of claim 1, wherein the computer program is a payment application.

5. The method of claim 2, wherein the account is a credit card account, and the association is a credit card association.

6. The method of claim 1, further comprising:
authenticating the customer; and
electronically activating the identifier.

7. The method of claim 1, wherein the identifier is a token.

8. The method of claim 1, further comprising:
receiving an update for the identifier; and
electronically communicating the update to at least one of the computer program and the issuer.

9. The method of claim 1, further comprising:
receiving an update for the identifier; and
electronically communicating the update to at least one of the computer program, the issuer, and the association.

10. A system for token provisioning using a third party provider, comprising:
an electronic device comprising an electronic device computer processor executing a computer program;
a third party provider information processing apparatus comprising a third party provider computer processor;
an association information processing apparatus comprising an association computer processor; and
an issuer information processing apparatus comprising an issuer computer processor;
wherein:
the third party provider information processing apparatus receives from the computer program a request to provision an identifier for an account associated with a customer to the computer program;
the third party provider information processing apparatus generates the identifier;
the third party provider information processing apparatus creates an association of the identifier and the account;
the third party provider information processing apparatus stores the association of the identifier and the account in a third party provider vault;
the third party provider information processing apparatus electronically communicates the association of the identifier and the account to the issuer information processing apparatus;
the third party provider information processing apparatus receives a cryptogram from the issuer information processing apparatus; and
the third party provider information processing apparatus electronically communicates the cryptogram and the association of the identifier and the account to the computer program.

11. The system of claim 10, wherein the third party provider information processing apparatus electronically communicates the cryptogram and the association of the identifier and the account to the association information processing apparatus.

12. The system of claim 10, wherein the computer program is a mobile electronic wallet.

13. The system of claim 10, wherein the computer program is a payment application.

14. The system of claim 13, wherein the account is a credit card account, and the association is a credit card association.

15. The system of claim 10, wherein the third party provider information processing apparatus authenticates the customer; and
the third party provider information processing apparatus electronically activates the identifier.

16. The system of claim 10, wherein the identifier is a token.

17. The system of claim 10, wherein the third party provider information processing apparatus receives an update for the identifier and electronically communicates the update to at least one of the computer program and the issuer information processing apparatus.

18. The system of claim 10, wherein the third party provider information processing apparatus receives an update for the identifier and electronically communicates the update to at least one of the computer program, the issuer information processing apparatus, and the association information processing apparatus.
